(19) United States
(12) Patent Application Publication
(10) Pub. No.: US 2015/0253846 A1
(43) Pub. Date: Sep. 10, 2015

(54) Reusable Touchscreen Pad

(71) Applicant: Daniel Vinnola, Golden, CO (US)

(72) Inventor: Daniel Vinnola, Golden, CO (US)

(21) Appl. No.: 14/608,416

(22) Filed: Feb. 18, 2015

(51) Int. Cl. G06F 3/01; G06F 3/044; G06F 3/0354

(52) U.S. Cl. CPC G06F 3/014; G06F 3/03545; G06F 3/044; G06F 2203/0331

(57) ABSTRACT

The patent I am filing for is for reusable set of pad that can be used to interact with touchscreen electronic devices. These pads will contain a reusable adhesive that will allow them to be removed and reapplied when necessary when needed by the user to a variety of surfaces including cloth and latex gloves and finger coverings.

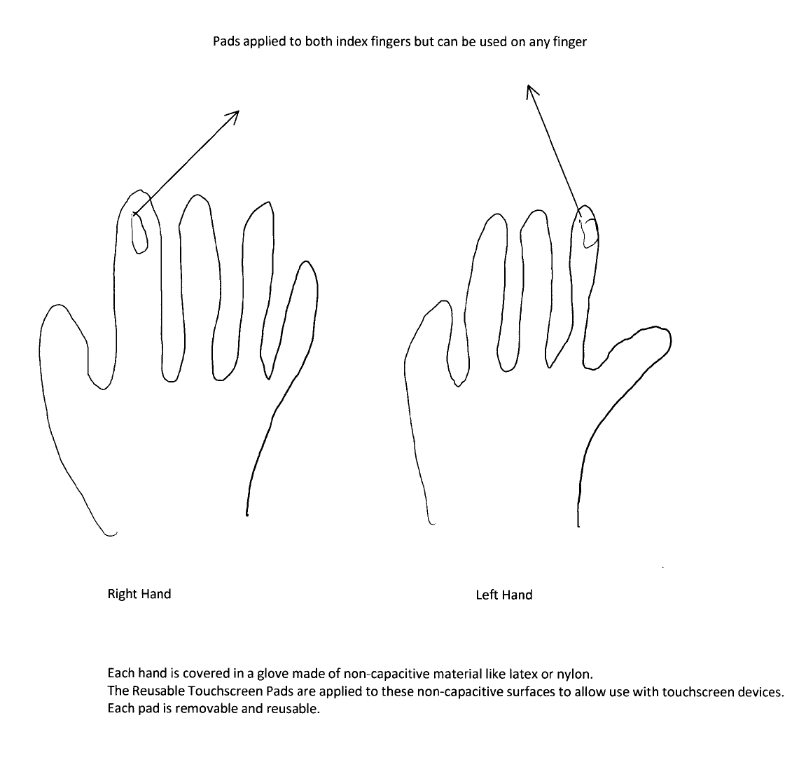

### BRIEF DESCRIPTION OF SPECIFICATION

The drawings submitted are representations of the human hands, both left and right. The depictions are to show the placement of the removable pads on the index fingers. These pads are the capacitive pads that can be placed on any or all fingers required by a person to use their touchscreen device. The hand depicted are assumed to be wearing some material that restrict interaction (for example cloth or latex gloves) thus requiring the invention.

### DESCRIPTION

The patent I am filing for is for reusable set of pad that can be used to interact with touchscreen electronic devices. These pads will contain a reusable adhesive that will allow them to be removed and reapplied when necessary when needed by the user.

The outside facing aspect of the pad will be capacitive and will work with all touchscreen devices. The rear facing adhesive will attach to cloth, skin, or bandages applied to fingers.

The removable pad adhesive is cloth and color safe, and will adhere to fabric, plastic, and rubber.

The pads will be sized according to a set specification and need. Male and female fingers are different sized so each set of pads will be sized accordingly.

The thickness of the pad will be less than a millimeter in size to keep tactile feel when using devices.

1. Currently there exists gloves and other items of covering that go on human hands that allow interaction with capacitive touch screen devices. These articles are specialized and require separate purchase. If an individual possess gloves without this feature they need to remove them to use the capacitive screen. Further, if an individual is using a bandage or some other covering on their fingers, their ability to interact with the electronic screen is severely limited.
If a individual does not possess a pair of these specialized gloves, or is wearing latex gloves, or is wearing a bandage, they cannot effectively interact with their devices. My claim is to allow the user to adhere these pads to any article worn on the fingers so they can allow them to use their devices. These pads are removable and reusable so they can be applied to any article of clothing or bandage needed. These will also have use in the medical field where professionals need to wear nitrile or latex gloves.
The pads will be also increase grip on the devices when held in hand.
